(19) United States
(12) Patent Application Publication
(10) Pub. No.: US 2012/0303537 A1
(43) Pub. Date: Nov. 29, 2012

(54) Intellectual Property Right Valuation Index And A Method And A System For Creating Such An Index

(75) Inventors: Martin Bader, Rorschach am Bodensee (CH); Hendrik Vogel, Syke (DE); Marc Tobias, Munchen (DE); Frauke Rüther, Bispingen (DE); Oliver Gassmann, St. Gallen (CH)

(73) Assignees: BGW AG, Rohrschach (CH); UNIVERSITAT ST. GALLEN (HSG), St. Gallen (CH)

(21) Appl. No.: 13/449,064

(22) Filed: Apr. 17, 2012

Related U.S. Application Data
(60) Provisional application No. 61/491,042, filed on May 27, 2011.

(51) Int. Cl. G06Q 50/00

(52) U.S. Cl. 705/310

(57) ABSTRACT

A method is disclosed for creating an IP right valuation index for an IP portfolio related to an IP right comprising: capturing a quality indicator signal relating to quality indicator data of the IP right; generating a technology field signal relating to a technology field of the IP right; measuring individual IP technology relevance comprising a ratio of the generated technology field signal and the captured quality indicator signal; capturing a total number signal relating to a total number of IP rights in the technology field; determining an IP portfolio signal relating to the number of IP rights within the captured total number signal having ownership of the IP right; measuring IP portfolio strength comprising a ratio of the determined IP portfolio signal and the captured total number signal; and creating an IP right valuation index comprising a product of the individual IP technology relevance and the IP portfolio strength.

### CROSS-REFERENCE TO RELATED APPLICATIONS

This application claims priority to U.S. Provisional Application Ser. No. 61/491,042 filed May 27, 2011, the entire contents of which are hereby incorporated by reference.

### TECHNICAL FIELD

The present invention relates to an Intellectual Property (IP) right valuation index and a method and a system for creating such an index, the index is for an IP portfolio relating to an IP right, including an IP right in patents, trademarks, designs, copyrights and trade secrets.

### BACKGROUND ART

As discussed in many scientific studies and management articles, companies do not use efficiently their IP and its strategic value. The same has been pointed out in several company projects at the Institute for Technology Management at the University of St. Gallen (ITEM-HSG) and its management advisory spin-off, the BGW AG. This fact is surprising. The majority of technological improvements of companies is documented in patent applications. The strategic use of these resources can lead to important new revenue sources and further commercial advantages. This all support the main goal of companies to develop significant shareholder value. At the same time IP right and patent portfolio value assessment are upcoming issues in the financial environment of new stock market indices and innovative financial products.

But how can companies analyze and evaluate their patent portfolio in an efficient hands-on way? Which tools enable them to compare their patent portfolio to those of competitors and rate its strategic value? Up to now valuation and rating of patents or patent portfolios is normally conducted in concrete business cases, licensing deals or technology transfer, e.g. IP infringement cases. Moreover IP valuations are typically performed as part of an asset analysis in M&A activities or due diligence processes in different investment contexts. But even in these typical IP transaction situations, reaching an agreement on the value is the most difficult hurdle for buyer and seller to agree on. Often resource-intensive expert valuation is needed. Here already an efficient objective quantitative approach would support and facilitate the transaction process. Further on efficient benchmarking and comparison would enable companies to compare their IP output with their competitors.

Patent benchmarks provide useful insights and help analyzing actual and even future technological strength within an industry. But existing objective quantitative methodologies/approaches are still in the development phase. They show different limitations e.g. missing methodological transparency or regional concentration on US patents. However, one can find aggregate information on patent activities through quantitative benchmarks in journals and magazines, e.g. in the Wall Street Journal.

In the last years a change in the role and activities of patent departments could be observed, away from classical patent administration activities to a strategic patent portfolio management. To efficiently fulfill the related comprehensive responsibilities these departments are looking for hands-on objective management approaches, e.g. to efficiently value the patent quality.

Top-level management is starting to understand that the knowledge on their companies' IP strategic value support strongly the development of competitive advantages. Systematic use of patent information, e.g. the valuation of patent portfolio gained increased significance in the past years. Today, intangible assets are used in financial instruments in a global market. The intangible book value as a percentage of market capitalization of the S&P500 is nearly doubling every ten years since 1975 and has now reached about 15%. However innovative approaches to analyze efficiently companies IP for financial products is still missing. At the same time an important change in the role of the IP department could be observed, away from classical patent administration activities to a strategic patent portfolio management with both, deep market and technology insights as well as close interaction with the R&D and Marketing department. In addition many studies show that a direct correlation exists between strategic patent management, technological leadership, and corporate performance, particularly considering return on investment (ROI) aspects. One can derive that in future knowledge on the patent portfolio's value and its objective quantitative analysis will be used in three directions: strategic, controlling and communication. Top management especially in companies with larger patent portfolios will point on these directions especially during the annual budget negotiations with the IP Department, summarized in the following question: Is the enterprise's patent portfolio adequate, of high quality, and valuable?

The task of assessing the value of one single patent is already a particularly difficult one. Moreover to assess the strategic value of an entire patent portfolio seemed to be long time impossible or too resource intensive. Many companies just count their patents in a technology field. But this method provides only little evidence regarding the innovative strength. 90% of the total financial value of granted European patents can be attributed to just 20% of all European patents. Therefore practitioners and also scientists are “unhappy” with this approach. Especially the large amount of skewness in the distribution leads to rather pessimistic implications for the use of patent counts.

In order to see whether the patent portfolio is adequate, of high quality and valuable, a comparison with the patent portfolios of competitors can be constructive. Single-Patent review based audits are one way assessing the strategic value. However, they often generate an overwhelming amount of data meaning a very resource intensive task. At this point patent indices come into play. Based on different rating or valuation methodologies they compare the strategic value of patents or a patent portfolio of a company with its competitors. However existing approaches show still important limitations.

Therefore an efficient hands-on approach that gives concrete information on the value of a patent and a related patent portfolio based on objective quantitative data is still needed.

### SUMMARY OF THE INVENTION

In accordance with an aspect of the invention, an IP right valuation index for an IP portfolio related to an IP right is disclosed. The IP right valuation index comprises: a quality indicator signal relating to stored quality indicator data of the IP right to be valuated; a technology field signal relating to a technology field of the IP right to be valuated; an individual Intellectual Property technology relevance comprising a signal ratio of the technology field signal and the quality indicator signal; a total number signal relating to a total number of IP rights being classified in the technology field of the technology field signal; an IP portfolio signal relating to the number of IP rights within the total number signal having the ownership of the IP right to be valuated; an IP portfolio strength comprising a signal ratio of the IP portfolio signal and the total number signal; and the IP right valuation index comprising a product of the individual Intellectual Property technology relevance and the IP portfolio strength.

In accordance with another aspect of the invention, a method for creating an IP right valuation index for an IP portfolio related to an IP right is disclosed. The method comprises the steps of: capturing a quality indicator signal relating to a stored quality indicator data of the IP right to be valuated; generating a technology field signal relating to a technology field of the IP right to be valuated; measuring an individual Intellectual Property technology relevance comprising a signal ratio of the generated technology field signal and the captured quality indicator signal; capturing a total number signal relating to a total number of IP rights being classified in the technology field of the technology field signal; determining an IP portfolio signal relating to the number of IP rights within the captured total number signal having the ownership of the IP right to be valuated; measuring an IP portfolio strength comprising a signal ratio of the determined IP portfolio signal and the captured total number signal; and creating an IP right valuation index for the IP right to be valuated comprising a product of the individual Intellectual Property technology relevance and the IP portfolio strength.

In accordance with another aspect of the invention, a computerized IP right valuation system for creating an IP right valuation index for an IP portfolio related to an IP right is disclosed. The system comprises: a computing device configured to capture a quality indicator signal relating to a stored quality indicator data of the IP right to be valuated; the computing device being configured to generate a technology field signal relating to a technology field of the IP right to be valuated; the computing device being configured to measure an individual Intellectual Property technology relevance comprising a signal ratio of the generated technology field signal and the captured quality indicator signal; a computing device configured to capture a total number signal relating to a total number of IP rights being classified in the technology field of the technology field signal; the computing device being configured to determine an IP portfolio signal relating to the number of IP rights within the captured total number signal having the ownership of the IP right to be valuated; the computing device being configured to measure an IP portfolio strength comprising a signal ratio of the determined IP portfolio signal and the captured total number signal; and the computing device being configured to create an IP right valuation index for the IP right to be valuated comprising a product of the individual Intellectual Property technology relevance and the IP portfolio strength.

In a further aspect, the invention provides an Intellectual Property right valuation index for an Intellectual Property portfolio related to an Intellectual Property right. In some embodiments, the Intellectual Property right valuation index comprises at least one quality indicator signal relating to at least one stored quality indicator data of said Intellectual Property right to be valuated; at least one technology field signal relating to at least one technology field of said Intellectual Property right to be valuated; an individual Intellectual Property technology relevance comprising a signal ratio of said technology field signal and said quality indicator signal; at least one total number signal relating to a total number of Intellectual Property rights being classified in the technology field of said technology field signal; an Intellectual Property portfolio signal relating to the number of Intellectual Property rights within the total number signal having the ownership of said Intellectual Property right to be valuated; an Intellectual Property portfolio strength comprising a signal ratio of said Intellectual Property portfolio signal and said total number signal; and the Intellectual Property right valuation index comprising a product of said individual Intellectual Property technology relevance and said Intellectual Property portfolio strength.

In some embodiments, for example, of the Intellectual Property right valuation index, the captured quality indicator signal comprises at least one of: stored forward citation data with zero or more forward cited Intellectual Property rights, each forward cited Intellectual Property right having at least one of a creation date and a publication date; a stored backward citation data with zero or more backward cited Intellectual Property rights, each backward cited Intellectual Property right having at least one of a creation date and a publication date; a stored Intellectual Property age data with zero or more age-related Intellectual Property rights, each age-related Intellectual Property right having at least one of a creation date and a publication date; and stored Intellectual Property inventor data with zero or more inventor-related Intellectual Property rights, each inventor-related Intellectual Property right having inventor data and at least one of a creation date and a publication date.

In some embodiments, for example, of the Intellectual Property right valuation index, the forward citation data being considered for the individual Intellectual Property technology relevance comprises at least one of: a creation date or publication date similar to a creation date of said Intellectual Property right to be valuated; a creation date or publication date included in a time period of a life cycle of said technology field signal, said time period starts with a creation date of said Intellectual Property right to be valuated; and a country code, said country code indicates a filing country of said cited Intellectual Property right; a forward citation signal being considered for the individual Intellectual Property technology relevance comprises a citation practice factor, said citation practice factor is predetermined and indicative for a citation practice in said filing country. In some embodiments, the backward citation data being considered for the individual Intellectual Property technology relevance comprises at least one of: a creation date or publication date similar to a creation date of said Intellectual Property right to be valuated; a creation date or publication date included in a time period of a life cycle of said technology field signal, said time period starts with a creation date of said Intellectual Property right to be valuated; and a country code, said country code indicates a filing country of said cited Intellectual Property right; a backward citation signal being considered for the individual Intellectual Property technology relevance comprises a citation practice factor, said citation practice factor is predetermined and indicative for a citation practice in said filing country. In some embodiments, the Intellectual Property age data being considered for the individual Intellectual Property technology relevance comprises at least one of: a creation date or publication date similar to a creation date of said Intellectual Property right to be valuated; and a creation date or publication date included in a time period of a life cycle of said technology field signal, said time period starts with a creation date of said Intellectual Property right to be valuated. In some embodiments, the Intellectual Property inventor data being considered for the individual Intellectual Property technology relevance comprises at least one of: a creation date or publication date included in a time period of a life cycle of said technology field signal, said time period starts with a creation date of said Intellectual Property right to be valuated.

In some embodiments, for example, of the Intellectual Property right valuation index, a captured quality indicator signal being considered for the individual Intellectual Property technology relevance is normalized to be included in a predetermined value range. In some embodiments, a captured quality indicator signal being considered for the individual Intellectual Property technology relevance comprises a standard deviation factor of each cited Intellectual Property right, said standard deviation factor is included in a predetermined value range.

In some embodiments, for example, of the Intellectual Property right valuation index, if the captured quality indicator signal relates to one or more Intellectual Property rights; each related Intellectual Property right is identifiable by means of at least one identification number; said identification number is a priority number; two or more related Intellectual Property rights having the same priority number form individual members of a family; and said captured quality indicator signal for being considered for the individual Intellectual Property technology relevance comprises at least one of: a family size factor, said family size factor is an integer and indicative for a number of individual members of a family; an Intellectual Property legal status factor, said Intellectual Property legal status factor is predetermined and indicative for a legal status of an individual member of a family.

In some embodiments, for example, of the Intellectual Property right valuation index, the Intellectual Property right to be valuated has a country code, said country code indicates a filing country of said Intellectual Property right to be valuated; and said Intellectual Property right valuation index is multiplied with an individual Intellectual Property market strength comprising a purchasing power factor, said purchasing power factor is predetermined and indicative for a purchasing power in said filing country; or wherein the Intellectual Property right to be valuated has a country code, said country code indicates a filing country of said Intellectual Property right to be valuated; and said Intellectual Property right valuation index is multiplied with an individual Intellectual Property market strength comprising a technology importance factor, said technology importance factor is predetermined and indicative for a technology importance of said Property right to be valuated in said filing country.

In some embodiments, for example, of the Intellectual Property right valuation index, wherein the Intellectual Property right to be valuated is identifiable by means of at least one identification number; said identification number is a priority number and a filing number; the Intellectual Property right to be valuated forms a family with individual members having the same priority number but different filing numbers; and said Intellectual Property right valuation index is at least one of: multiplied with a market strength comprising a family size factor, said family size factor is an integer and indicative for a number of individual members of said family; and multiplied with a market strength comprising an Intellectual Property legal status factor, said Intellectual Property legal status factor is predetermined and indicative for a legal status of an individual member of a family.

In some embodiments, for example, of the Intellectual Property right valuation index, the Intellectual Property portfolio strength comprising a logarithm of a signal ratio of said Intellectual Property portfolio signal and said total number signal.

In yet another aspect, the invention provides a computerized Intellectual Property right valuation system for creating an Intellectual Property right valuation index for an Intellectual Property portfolio related to an Intellectual Property right, said system comprising: a computing device configured to generate at least one forward citation request signal relating to said Intellectual Property right to be valuated; at least one computerized storage device configured to capture said forward citation request signal, said computerized storage device being configured to store at least one forward citation data of said Intellectual Property right to be valuated; a computing device configured to capture at least one forward citation signal from said computerized storage device, said forward citation signal being responsive to said forward citation request signal and relate to said stored forward citation data of said Intellectual Property right to be valuated; said computing device being configured to generate at least one technology field signal relating to at least one technology field of said Intellectual Property right to be valuated; said computing device being configured to measure an individual Intellectual Property technology relevance comprising a signal ratio of said generated technology field signal and said captured forward citation signal; a computing device configured to generate at least one technology field request signal relating to said technology field signal; at least one computerized storage device configured to capture said technology field request signal, said computerized storage device being configured to store at least one Intellectual Property right, said stored Intellectual Property right being classified in at least one technology field; a computing device configured to capture at least one total number signal from said computerized storage device, said total number signal being responsive to said technology field request signal and relate to a total number of Intellectual Property rights being classified in the technology field of said technology field signal; said computing device being configured to determine an Intellectual Property portfolio signal relating to the number of Intellectual Property rights within the captured total number signal having the ownership of said Intellectual Property right to be valuated; said computing device being configured to measure an Intellectual Property portfolio strength comprising a signal ratio of said determined Intellectual Property portfolio signal and said captured total number signal; and said computing device being configured to create an Intellectual Property right valuation index for said Intellectual Property right to be valuated comprising a product of said individual Intellectual Property technology relevance and said Intellectual Property portfolio strength.

### BRIEF DESCRIPTION OF THE DRAWINGS

The foregoing features of embodiments will be more readily understood by reference to the following detailed description, taken with reference to the accompanying drawings, in which:

FIG. 1 shows the monetary valuation of patents;

FIG. 2 shows qualitative indicators for the rating of patents;

FIG. 3 shows qualitative indicators for the rating of patents (suite of FIG. 2);

FIG. 4 shows the typology of patent value indicators;

FIG. 5 shows the integrated method approach of present invention;

FIG. 6 shows a flowchart with method steps of present invention;

FIG. 7 shows a diagram of an IP portfolio.

### DETAILED DESCRIPTION OF SPECIFIC EMBODIMENTS

The value analysis of companies' patent portfolio represents an upcoming issue in managerial literature. By the term “valuation” of patent portfolios, according to present invention one understands the assessment of quality and relevance of a given patent portfolio. The assessment should include three main factors: a technological component related to the inventive-technological strength of the patents, a market component related to the attractiveness of the markets where the patents have been filed and a portfolio-synergy component comprising an assessment of the importance of the portfolio in its entirety within the competitive environment. The assessment of these three factors can be accomplished by experts based on subjective opinions or by combining objective quantitative data.

In scientific literature and praxis one can find the terms “rating” and “evaluation” (see Table 1). Some authors differentiate between these and “valuation” as the assessment of a financial value. With regard present invention, the term “valuation” is defined as a quality assessment of the strength of patents and their portfolio in a competitive environment. For this one combines objective quantitative databases.

Qualitative Versus Quantitative Methods

In order to structure the different directions to value a patent/patent portfolio, Table 1 shows the main directions.

TABLE 1

| | Qualitative Approaches | Quantitative Approaches |
|---|---|---|
| Valuation | Assignment of a monetary | Assignment of a monetary |
| | value to a patent/patent | value to a patent/patent |
| | portfolio by experts | portfolio by a market |
| | | mechanism (auction, |
| | | financial market) |
| Rating | Assignment of qualitative | Assignment of |
| | indicators based on a | quantitative indicators |
| | expert opinions | based on objective data |
| | | from market and patent |
| | | databases (Patent |
| | | Indices) |

Qualitative methods are mostly usable for single patent reviews best in smaller patent portfolios. They can be distinguished by their valuation dimension. The most elaborate ones use three dimensions, the relative patent position the attractiveness of the technology as well as the impact of the technology. Quantitative methods base on objective data, e.g. patent statistics, citations, market data.

The development of a prospective financial model for valuation based upon the business supported by the IP is a highly critical task. Also the calculation of the present value of the incremental profit attributed to the IP represents difficult analysis. In the past a variety of research papers analyzed the monetary valuation of patents and IP portfolios. Extensive lists of influencing factors and value drivers have been compiled. Out of this three main value measurement constructs can be identified:
Market orientation: using comparable patents or licenses by interaction of supply and demand on the market;
Cost orientation or license analogy: The sum of all real, fictitious and/or potential costs and expenses which accrue in connection with the development or acquisition, maintenance, defense and marketing of a patent;
Profit orientation: Discounted profits, earnings or cash flows, which have been generated with the patent or can be expected in the future.

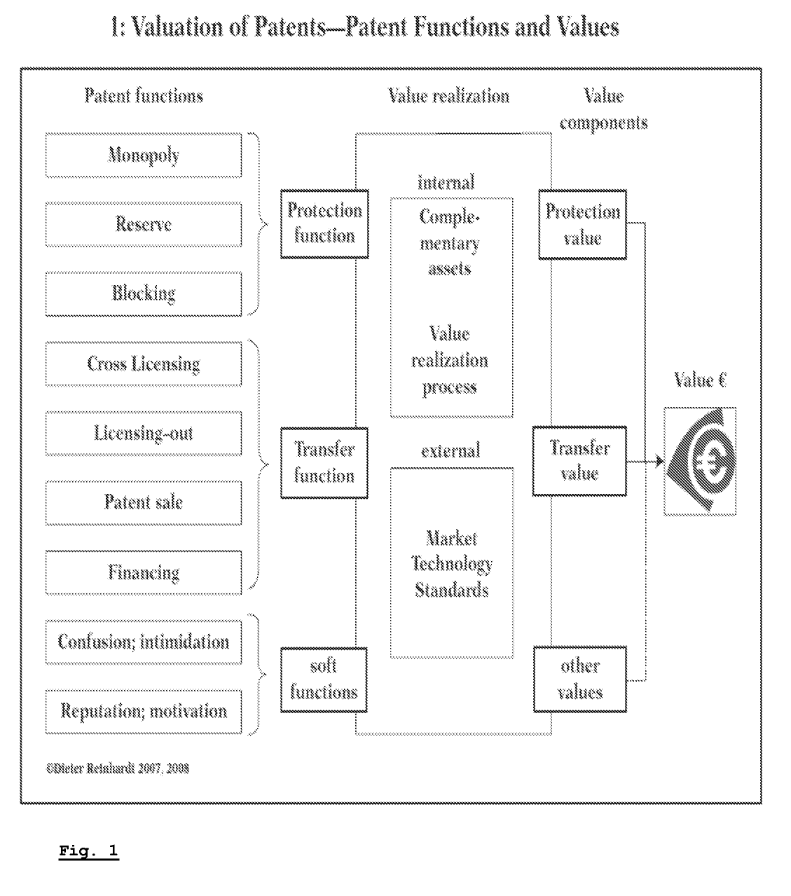

FIG. 1 shows how a monetary value of a patent can be identified (Ernst, H. and Omland, N.: “The Patent Asset Index—A new approach to benchmark patent portfolios”, World Patent Information, 2010).

Qualitative valuation can only be based on the subjective opinion of experts. However it is widely accepted and commonly used. But quantitative valuation methods become more and more important for companies. Most of the valuation approaches are used in the context of a concrete patent litigation, exchange or licensing process.

One major limitation of monetary valuation methods is the need of a direct link between a patent and a specific product. Therefore the effort depends largely on the industry and the specific patent case. Moreover, problems occur while determining the value for a large set of patents and/or a patent portfolio, often related to high costs and important workload. The qualitative valuation exhibits again the limitation that it depends on personal subjective assumptions. It therefore might miss transparency and not respect objectivity criteria. The monetary valuation of IP rights provides often only pseudo-objective results.

As business needs an approach to value a patent/patent portfolio one can ask for a sort of counter calculation. Therefore, a new approach is required that represents more objectivity and transparency.

A well established financial market for IP would be one solution. Up to now first financial products can be traded in the USA. A part from this the European Commission is heading for a European financial market.

As already discussed, the strategic role of patent portfolio management is changing. IP departments play a more strategic role. Therefore the importance of efficient approaches raised in the last years. For managing a patent portfolio, the scores can be used to make intelligent decisions in regards to filing, particularly foreign filing, as well as judging whether to maintain or abandon patents.

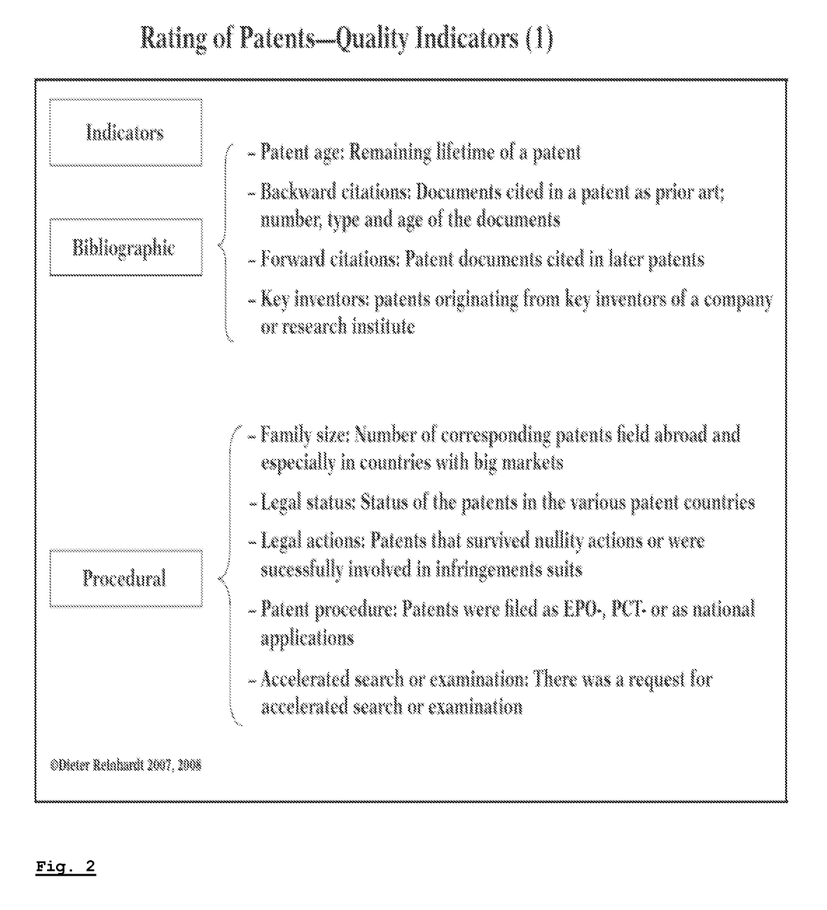

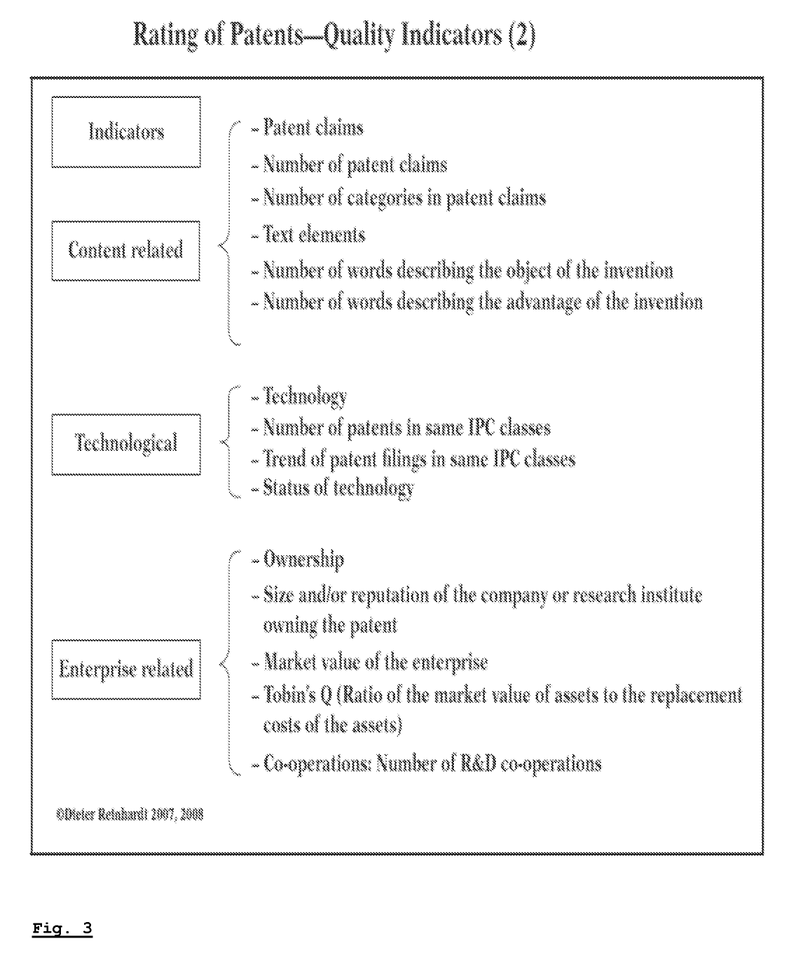

FIGS. 2 and 3 show main quality indicators which can be used to develop a non-financial valuation of patents and of a patent portfolio (Ernst, H. and Omland, N.: “The Patent Asset Index—A new approach to benchmark patent portfolios”, World Patent Information, 2010). Same as for qualitative valuation approaches main limitations at the non-financial qualitative assessment level are the high costs of individual patent rating and missing objectivity, as these ratings will be conducted by experts.

Qualitative non-financial valuation is often used in patent audits. A patent audit firstly aims to compile available patents in a company and then to determine technological, legal and value-relevant information on an individual basis. During a typical IP organization audit leading technologist, patent attorneys and business development personnel answer a set of questions that are catalogued in a database. Audits of this type have been discussed in various papers.

Most of the patent audit data is subjective in nature since the information is obtained from individuals through interviews. Further main problems related to this qualitative approach are relatively high costs and lack of resources. A reasonable estimate for identifying and qualifying prospects, but excluding patent attorney and reverse engineering services, is $200 to $500 per patent for outside experts. The bulk of the time and expense during such a review is due to the review and analysis of a few high potential patents. Such a qualitative portfolio analysis usually needs three to nine months or even longer, depending on the size of the portfolio and the resources available. Moreover it might be necessary to value the patent at different stages of the patent life cycle, which implies even a higher resource investment.

Since some years, quantitative patent indices for non-financial valuation have been developed. Their goal is different from the before mentioned approaches. They aim to measure/score efficiently the value of patents or a patent portfolio. They help to identify strategic needs and options for investments or to show the innovative strength of a company to clients or investors. These indicators include objective quantitative factors like market or competitive information, R&D criteria, production criteria or overlapping criteria. The developed algorithms creates a “score” based upon different indicators, e.g. the number of forward citations of the patent, the patent's age, and other objective and quantitative information publicly available within patent and economic databases. But these methods also show limitations. The aggregation of data leads to a distinctive level of fuzziness. However, their growing relevance in future is quite obvious. Moreover the approaches develop more efficient algorithms and transparent methodologies.

### Patent Valuation Methods

### Existing Approaches

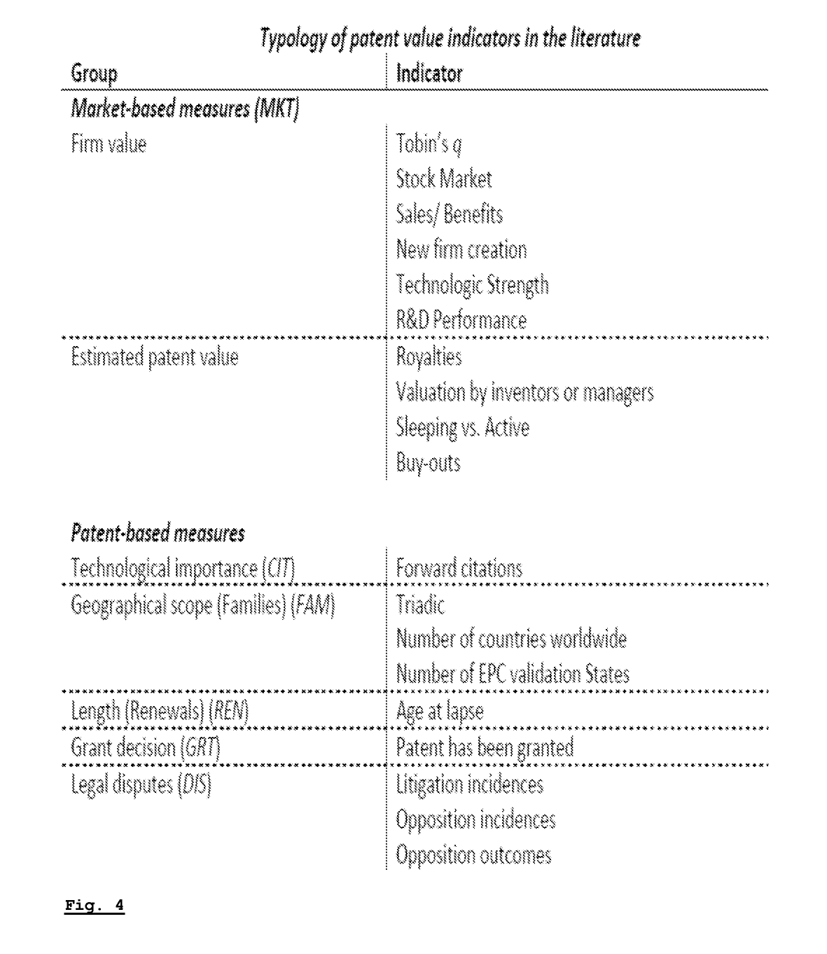

Until 2004 quantitative non-financial valuation (rating) methods had no importance in scientific literature. This changed and one can identify a new research direction. Also companies understand that it is not sufficient to measure the value of a patent portfolio by counting the patents. More elaborated methods were developed including complex calculation and different factors. The overall idea is to count objectively the weighted values of the patents. In order to receive an objective weighting factor different measures/indicators were developed. According to FIG. 4, they can be divided into two main categories: the “market-based” and the “patent-based” measures (van Zeebroeck, N. and van Pottelsberghe de la Potterie, B.: “Filing strategies and patent value”, Centre Emile Bernheim Working Paper N° 08/016, March 2008). For the first category, the underlying assumption is that the value of a firm's patent portfolio should be somehow reflected in its market value. Patent-based factors include mainly forward citations, but include also the size of families, renewals and oppositions.

The weighting factors are related to different value drivers. Many of these factors are used in the four actually most renowned patent value indexes.

All of these non-financial valuation/rating methods have in common that they use metrics to calculate a numerical value measuring the strength or quality of a patent portfolio. Comparing such values enables firms to benchmark their own patent portfolio against their competitor's one. In the following paragraphs four prior art non-financial valuation/rating methods will be described.

Patent Asset Index: The Patent Asset Index method according to Ernst, H. and Omland, N.: “The Patent Asset Index—A new approach to benchmark patent portfolios”, World Patent Information, 2010 evaluates a portfolio by assessing the value of each patent individually, therefore using a bottom-up approach. The rating of an individual patent is named Competitive Impact. It is calculated by the multiplication of two factors called Technology Relevance and Market Coverage. The Patent Asset Index is the sum of the Competitive Impacts of a portfolio. Worldwide patents are included.

The first dimension of the Competitive Impact is Technology Relevance. It is a measure for the importance of the invention disclosed in a patent. This is assessed by comparing the number of citations the patent received from later patents (forward citations) to the number of forward citations an average patent receives. By adjusting “for age, patent office practices and technology field”, a numerical value is extracted. Its worldwide average is one. Therefore, a patent with a Technology Relevance of one is as relevant as the average patent. Patents with a value of two are twice as important as the average patent in the same technology field.

The second factor Market Coverage measures the economic size of the markets protected by the selected patent. Thus, the Gross National Income of the protected markets is summed up and divided by the Gross National Income of the USA. The numerical value derived by this method is a relative measure. It allows one to analyze broad the protection of the patent is. The Patent Asset Index has been applied in the chemical sector. The portfolios of the year 2008 have been assessed. According to this rating, BASF has the strongest portfolio followed by Bayer and DuPont. The Patent Asset Index received positive feedback from BASF and Dow Chemical Company.

Patent Ratings: Like the Patent Asset Index, Patent Ratings according to U.S. Pat. No. 6,556,992B1 evaluates a portfolio by taking into account every single patent, again using only a bottom-up approach. The score attached to a patent is called Intellectual Property Quotient (IPQ). The arithmetic average of the score given to portfolio's patents is calculated to rank a company's IP.

A patent is scored by a regression model that statistically compares maintenance rates to certain intrinsic parameters. Hence, IPQ is predictive for mortality rates. A patent with a high IPQ score is very likely to survive its maximum 20 years of lifetime. Additionally, a statistic correlation between commercialization rates and IPQ score has been found. Nevertheless it is not proved if the IPQ score has a meaning concerning royalty rates or market value of a patent.

Patent Ratings uses more than 50 independent and objective parameters that cover technology, prior art, disclosure, claims, prosecution and ownership among others. The raw scores given by the computer model are then adjusted mathematically to a normal distribution with a median score of 100. Up to now, only patents issued for the USA are ranked. Yet, there have been efforts to expand this service to a global patent database.

1790 Analytics: In contrast to the two former rating methods, 1790 Analytics according to U.S. Pat. No. 6,175,824B1 assesses directly the quality of a portfolio, using a top-down approach. This assessment is the product of five factors that are: Number of patents in a portfolio which should be evaluated, Pipeline Growth, Pipeline Impact, Pipeline Generality, Pipeline Originality. Only portfolios with a number of patents greater than 25 are rated to avoid statistical inaccuracies due to small samples. Pipeline Growth measures how many patents have been issued in comparison to former years, by calculating the quotient of the number of patents issued to the company in the current year and the average of issued patents in the last five years.

Pipeline Impact depicts the relevance of a portfolio. Scientific literature states that forward citations are a significant measure to assess the importance of a patent. The citations that patents of the last five years received by patents issued in the current year are counted and compared to the citations a “control set of patents” received. Moreover the metrics contains self-citations. Thus, for a firm, which mainly cites its own patents, the Pipeline Impact is reduced.

An invention may be used in many different ways and may be applied in various technological areas. The factor Patent Generality takes into account this broadness of applications. Patents that are cited by later patents from different technological areas are supposed to be more valuable.

The last factor is called Pipeline Originality. A portfolio has a high Pipeline Originality score if the patents cite a lot of patents from different technological areas as prior art. This metric is based on the assumption that a high originality is an indicator for groundbreaking inventions. These inventions are supposed to be more valuable.

The Patent Board™: The Patent Board™ is a ranking developed by The Patent Board™ published on a weekly basis in the Wall Street Journal. Patent portfolios of equivalent industry areas are compared by a bottom-up approach analyzing the Technology Strength. The results are condensed into the Patent Scorecard. The Patent Board™ uses approximately 50 parameters, which can be clustered into six groups. These groups are Technology Strength, Industry Impact, Research Intensity, Science Strength, Patents Granted and Innovation Cycle Time. Technology Strength is the most important metric as companies are ranked according to this value.

Patents Granted reflects the number of patents that were granted to a company in a year relevant for the rating. The Patent Board™ used to refer to patent filings in the USA only. However, steps to extend the scope of rated patents have been taken. Industry Impact score provides information about the influence a portfolio has on developments in the same technological area. Forward citations are an important metric for this score. For Innovation Cycle Time the median age of patents in a portfolio is calculated. Therefore, it depicts how old the technology is on which the portfolio is based on. Companies can thus be evaluated according to the speed at which they incorporate and produce new technology. Science Strength and Research Intensity describe to what extent a portfolio is linked to scientific knowledge. A high Research Intensity is achieved if the patents of a portfolio are frequently mentioned in scientific journals. Science Strength measures the scope of science used to build the patent portfolio.

Even if this approach is based on different scientific results it is still incomplete. It concentrates on the technological strength, neglecting any market coverage indicators. Moreover it includes only patents in the USA and is restricted to the patents granted within the last 52 weeks. Therefore international industry and market impact are difficult to measure. Many companies only file a small percentage of their patents in the USA. Also companies' recent innovation activities shown through applications are not observed by this index. Last we miss the integrated approach of an individual and a portfolio based analysis.

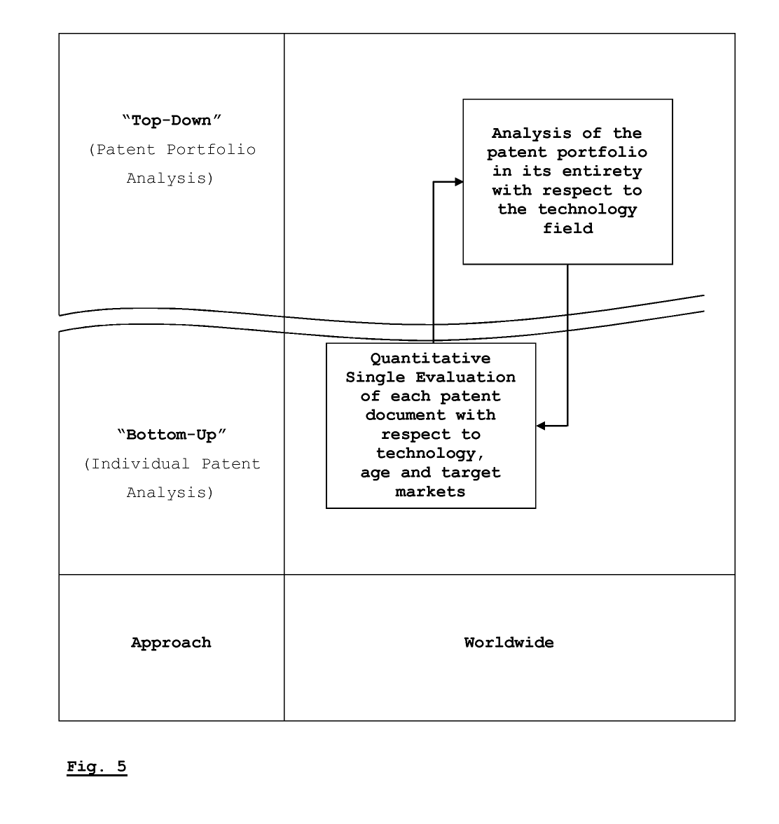

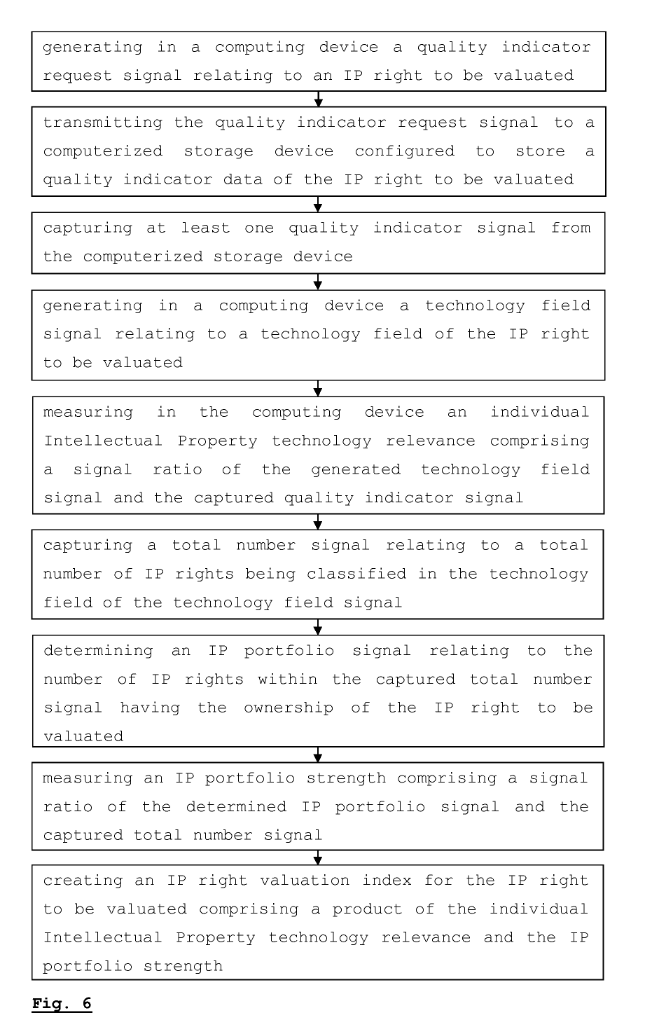

The present invention will now be described more fully with reference to FIGS. 5, 6 and 7 in which the preferred embodiment of present invention is shown. The subject matter of this disclosure may, however, be embodied in many different forms and should not be construed as being limited to the embodiment ser forth herein.

The description of four prior art methods shows clearly one gap, necessary to be closed by a complete valuation method. This gap is formed by the missing linkage between individual IP analysis and the overall IP portfolio analysis for an IP portfolio relating to an IP right.

Present invention solves this problem by using a unique combination of an individual IP/bottom-up method with an IP portfolio/top-down-method for the valuation of an IP right. The IP right may include patents, designs, trademarks, copyright and trade secrets. Moreover, The IP right may include granted patents, registered trademarks, registered designs, registered copyrights or any other granted or registered IP rights like registered utility models. Additionally, the IP right may include pending patent applications, pending design applications, pending trademark applications, or any other pending IP applications. In the following, the IP right will be often described in the form of patents or patent documents.

By combining top-down and bottom-up methods within one IP right valuation index, the advantages of qualitative and quantitative methods are combined. The bottom-up method is based on individual IP measurements. In contrast to a normal subjective qualitative analysis the IP right valuation index includes only objective quantitative parameters. At the same time, the IP right valuation index comprises a top-down method that considers the importance of the entire IP portfolio related to the underlying IP right.

The IP right valuation index is the first scientifically developed method that combines individual IP analysis (bottom-up) with an entire IP portfolio rating (top-down). Why is this combination necessary? To which extent does it deepen the insights about an IP portfolio? Does this method enhance the evidence of the value of patents and a patent portfolio?

The idea to develop an integrated method was born during discussions with managers from various companies. They asked why it was not possible to combine the advantages of qualitative research with quantitative data in one single hands-on method. The aim is to reduce complexity in their portfolio screenings and save costs for long-lasting individual qualitative patent reviews. However they did not wanted to miss the positive effects of a detailed view on each individual patent. But also from a scientific point of view, one can find strong arguments for the inventive two-side method.

The combination of a quantitative patent scoring and a qualitative patent audit provides valuable data that can be used to develop a patent portfolio strategy. It is the question how to integrate the two sides in one methodology. A graphical expression of technology strength and market strength would provide greater insight regarding the identification of those IP most likely to bring value to the enterprise. Especially technological impact of the IP and the importance of the market the patent addresses are key indicators of value.

Taken into account the needs and demands of companies, the different limitations presented beforehand and the advantages of an integrated method, the following main challenges were identified and categorized into two types that have to be tackled by present invention:

Methodological Challenges
Inclusion and weighting of different types of patent documents to cover also recent IP activities;
Integrated method including top-down (analysis of the entire portfolio) and bottom-up (analysis on individual patent level);
Worldwide and patent lifetime coverage;
Market and industry related economic data;
Developing a scientific method to measure the portfolio-effect of patents in a companies' patent portfolio.

End-User Challenges

Transparency and “easy to understand”;

Objectivity of data;

Resource efficiency;

Technology view and future trends input.

These points were respected while developing the IP right valuation index P according to the following formula:

$$P = {\sum }_{k}^{n} {R}_{k} ( T , A , C ) * {M}_{k} * {N}_{k} ( T )$$

The IP right valuation index P comprises three factors:
Individual IP technology relevance R(T, A, C) as a function of the technology field T of an individual patent to be valuated, the age A of the individual patent to be valuated, and an individual quality indicator C; for a given technology field T and a given age A, k represents a hit number of a specific quality indicator C for the individual patent to be evaluated out of a total hit number n of the specific quality indicator C for all patent documents;

$$R ( T , A , C ) = \frac{{\int }_{0}^{k ( T , A )} C ( T , A ) d T}{{\int }_{0}^{n ( T , A )} C ( T , A ) d T}$$

the technology field T may related to a patent class like an International Patent Class or a U.S Patent Class; the technology field T may also relate to a more vaguely defined market like consumer products, pharmaceuticals, etc.; the technology field T may be freely defined according to keywords, search results, etc.
Individual IP market strength M:

$$M = {\sum }_{m = 0}^{n} Y ( m , y ) * X ( m , y ) * Z ( m , y )$$

X represents a qualitative country ranking, e.g. business environment risk index (BERI) for the market m of the patent to be evaluated and a time period y of economic data with a possible future and retrospective analysis;
Y represents a quantitative country indicator, including different leading, coincident and lagging indicators e.g. purchasing power parity share of a world total (PPPSH), industrial production, again for the market m of the patent to be evaluated and a time period y of economic data with a possible future and retrospective analysis;
Z represents a quantitative industry related indicator, e.g. industry-share of gross domestic product (GDP) for the market m of the patent to be evaluated and a time period y of economic data with a possible future and retrospective analysis.
IP portfolio strength N(T) as a function of a given technology field T of the patent portfolio related to the patent document to be evaluated including a relational term to the technology average or averaged portfolio strength within a technology field T.

The subject matter of the preferred embodiment of the invention relates to an IP right valuation index P for an IP portfolio related to an IP right to be valuated comprising a product of the individual IP technology relevance R and the IP portfolio strength N. Optionally, the IP right valuation index P comprises also the individual IP market strength M. IP The portfolio comprises one or more IP rights.

By doing so, the IP right valuation index P comprises the most powerful quality indicators: e.g. market value, oppositions/claim counts, forward citations, backward citations, and strategic importance of patent families. Transparency is assured by objective and publicly accessible databases. The IP right valuation index P overwhelms the different limitations of the prior art. It can help to answer top-management strategic questions and support the change as well as the different roles of IP today and in future.

As for this the IP right valuation index P can be used in the following situations mainly to be differentiated according to the field of application, 1) specific company level, 2) Key performance indicator (KPI) within governmental policy development level, and 3) financial market level:

1) Specific Company Level:
Strategic Support:
   Indicator for technology strategies and the patent portfolio management.
   Tool to analyze activities of competitors and clients.
Communication Instrument:
   External (investor relations; client communication-marketing tool).
   Internal (employee motivation).
Controlling/Management Tool:
   Objective assessment of single patent values and the patent portfolio as a whole.
   Development analysis over time, combination with further performance indicators.

2) KPI within Governmental Policy Development Level:
Analysis and benchmarking of regions, technology clusters and industry sectors to support governmental activities and policy measure development in order to enhance innovativeness and competitiveness.
Especially governmental institutions are constantly trying to enhance the innovativeness and competitiveness of regions and technology clusters. For this they need specific targeted indicators enabling the analysis of strength and weaknesses and development of effective policy measures. Patenting activities of a company are widely accepted to be a strong indicator for the innovativeness of the entity. The IP right valuation index P would enable governmental institutions to analyze their regions, technology clusters or industry sectors in charge by using the presented objective quantity-based methodology. The analysis would include the following steps:
   As first step a distinct definition of the field of technology and/or industry sector in the related region or cluster would be conducted, deriving afterwards potential companies to be analyzed. Hereafter it would be necessary to define benchmarking regions and/or clusters at a national or even international level including a first selection of potential companies.
   The second step includes the calculation of the IP right valuation index P and its three factors (R; M; N) for each company in the selected regions and/or clusters. As described above the patent portfolios of each selected company will be analyzed and calculated according to the given IP right valuation index P.
   As third step the weighted average of each region and/or technology cluster will be calculated. A simple summation and division of the IP right valuation index P values of the selected companies would not represent the real average. Therefore we would weigh the importance of each company within a region and/or technology cluster by taken into account the turnover and/or market share of the company.
The outcome will be a specific landscape displayed by the IP right valuation index P showing “hills and valleys” of innovativeness of the selected regions and/or technology clusters on a national and international level. This landscape could be individualized based on the different IP right valuation index P factors and taking into account further economic indicators as well as different time periods.

3) Financial Market Level:
IP right valuation index P as key performance indicator (KPI), e.g. within initial public offerings (IPO), mergers and acquisitions (M&A) or increase in share capital.
IP right valuation index P based equity funds.
IP right valuation index P based stock index.
Developing a financial market and/or financial products based on IP rights such as patent portfolios was longtime impossible as a simultaneous value assessment of many companies was not feasible in a resource-effective way. The IP right valuation index P would enable the development of such financial products by its efficient methodology. Moreover it is quantity-based, transparent and objective. As already mentioned patenting activities of companies are widely accepted to be a strong indicator for the innovativeness of the entity. Therefore a high-value patent portfolio will represent a powerful predictive indicator for future development and competitiveness of a company. The analysis would include the following steps:
   As first step a distinct definition of the field of technology and/or industry sector would be conducted, deriving afterwards potential entities and/or companies to be analyzed in-depth.
   The second step includes the calculation of the IP right valuation index P and its three factors (R; M; N) for each company to be selected for the equity funds and/or stock index or in focus for IPO, M&A or increase in share capital. As described above the patent portfolios of each selected company will be analyzed and calculated according to the given methodology.
   The third step differs according to the field of application:
      IP right valuation index P as key performance indicator (KPI), e.g. within initial public offerings (IPO), mergers and acquisitions (M&A) or increase in share capital.
      The most obvious application of the IP right valuation index P within the financial context includes the analysis of patent portfolios of companies involved in financial transactions. In some countries an analysis of the patent portfolio before issuing first time equities on a stock market (IPO) is even mandatory. In many industries, e.g. pharmaceutical, a comprehensive patent portfolio analysis represents the main criteria for investments. The IP right valuation index P could produce a first comprehensive value assessment of the patent portfolio and therefore of the company. Same for M&A or increase in share capital, the IP right valuation index P would enable to analyze and communicate efficiently to investors the value of the patent portfolio and therefore company in focus based on an objective assessment.
      IP right valuation index P based equity funds.
      In order to develop a patent portfolio based equity funds the issuer needs an efficient, objective and transparent methodology to analyze the patent portfolio of each company out of his investment portfolio. Based on this analysis he will be able to decide whether to invest and disinvest in a company.
      Efficiency is needed as the analysis of the patent portfolio has to be often repeated for a large number of potential investments. Objectivity and transparency are requested by professional and private investors. Both expect clear communication on the criteria and selection process before investing in the equity funds.
      The IP right valuation index P would rank the strength of the patent portfolio of the companies in focus, would enable to highlight variations and include assessment of future value development. All this enables the issuer to select the most promising and/or high-potential enterprises.
      IP right valuation index P based stock index.
      The most complex application of the IP right valuation index P would be to a patent portfolio valuation index based stock index. The IP right valuation index P could be used under the term “St. Gallen Patent Index” and/or “SGPI”. Like the NASDAQ 100 or the TECDAX a SGPI-INDUSTRY-INDEX could rank the companies listed within the normal stock indices. However a SGPI-INDUSTRY-INDEX would not mainly use market capitalization as indicator to rank the companies. The idea is to introduce a stronger indicator even enabling future value assessment.
      As patents and strong patent portfolios represent a comprehensive rationale for future innovativeness and competitiveness of a company it stands to reason that a SGPI-INDUSTRY-INDEX would include the most competitive companies within an industry. Such an index could also be calculated for each industry sector separately (e.g. a SGPI-BIOTECH-INDEX, SGPI-PHARMTECH-INDEX, SGPI-CHEMTECH-INDEX).
      The advantage of such an index could be to develop afterwards related financial products linked to the index, e.g. SGPI INDEX CERTIFICATES, SGPI EXCHANGE TRADED FUNDS or SGPI INDEX/EQUITY SWAPS.
         The three factors of the IP right valuation index P will be described now more in detail.

### Individual IP Technology Relevance R

The first factor, the individual IP technology relevance R represents a first implementation of the bottom-up method. In order to assess the value of an individual patent, the IP right valuation index P includes a methodology based on the forward citations as the strongest quality indicator identified in literature.

Individual quality indicators C are the most important determinant of patent value for market-based measures. Within the IP right valuation index P they explain the technological relevance of a patent. One can argue that technologically strong IP has the potential to capture larger market share. It may contribute significantly to the end product and place the IP holder in a powerful negotiating position for licensing agreements. Several individual quality indicators C may be used such as forward citations (a citation which occurs in forward direction on a timeline from the point of an older patent document), backward citations (the opposite, a citation which occurs in backward direction on a timeline from the point of a younger patent document, e.g. the classical prior art search), IP age, IP inventor (a key inventor within a technology field T), etc. Quality indicators contain significant information on the market value of firms. In addition to R&D performance indicators like e.g. share of sales by innovative products they help to analyze the “knowledge stock” of firms. The information value of this factor received considerable support in a study of medical scanning devices. It was found that the number of quality indicators received correlates highly with the patent right's value, but that the relationship is quite noisy.

To measure the individual IP technology relevance R, one may count the number of patents citing the patent to be valuated (forward citations as quality indicator). As simple counting of forward citations does not lead to valid information, the calculation contains several hints. E.g. it has to be considered, that the age of a patent has a “non-technological” influence on the quantity of forward citations. Older patents are likelier to be more often cited, than younger ones. Therefore, forward citation data being considered for the individual IP technology relevance R has a citation date included in a time period starting with a creation date of the patent to be valuated. Moreover industries and technology clusters show different citation practices. In fast-innovating sectors, like biotechnology or information technology (IT), patents can be characterized by relatively short life cycles. Therefore citations in the first years are much more observable in those industries than in classical industries. In other words, a forward citations being considered for the individual Intellectual Property technology relevance have a citation date included in a time period of a life cycle of the technology field T, the time period starts with a creation date of the patent to be valuated.

These factors are taken into account by differentiating the individual IP technology relevance R by age of the patent to be valuated and technology field T of the patent to be valuated. The IP right valuation index P therefore enables its users to select and analyze comparable patents of its company and competitors. By this the company receives a concrete idea on the technological and competitive relevance comparable to a qualitative single patent analysis by an expert.

As data source for the forward citations one may use the Worldwide Patent Statistical Database (PATSTAT) or another patent database like International Patent Documentation Center (INPADOC). PATSTAT is actualized every 6 Month, Therefore the IP right valuation index P refers to these due dates. The age for every patent is adjusted in the calculation to the nearest PATSTAT actualization date (before or after filing). Moreover, PATSTAT contains every patent ever granted, even if it is older than twenty years. The IP right valuation index P only considers patents up to the age of twenty years. To select the relevant patent document, one may use the unique application ID of a patent document. If there are several documents related to one application ID (e.g. translations, corrections, limitations) only the latest document (identified by the publication ID) will be selected.

In order to measuring an individual IP technology relevance R, a computing device is provided for generating at least one forward citation request signal relating to a IP right to be valuated. The computing device is a general purpose computing device with a microprocessor like a personal computer, or a laptop. The forward citation request signal is transmitted to a computerized storage device configured to store a forward citation data of the IP right to be valuated. The computerized storage device may be distant from the computing unit. The computerized storage device is a public or private database with a microprocessor. Transmission of the forward citation request signal may occur with the Internet Protocol with a cable or wireless. The computing device captures a forward citation signal from the computerized storage device, the forward citation signal being responsive to the forward citation request signal and relate to stored forward citation data of the IP right to be valuated. Transmission of the forward citation signal to be captured by the computing device may also occur with the Internet Protocol with a cable or wireless. A technology field signal is generated in a computing device, the technology field signal relates to a technology field T of the IP right to be valuated. An individual IP technology relevance R is measured in the computing device, which individual IP technology relevance R comprises a signal ratio of the generated technology field signal and the captured forward citation signal.

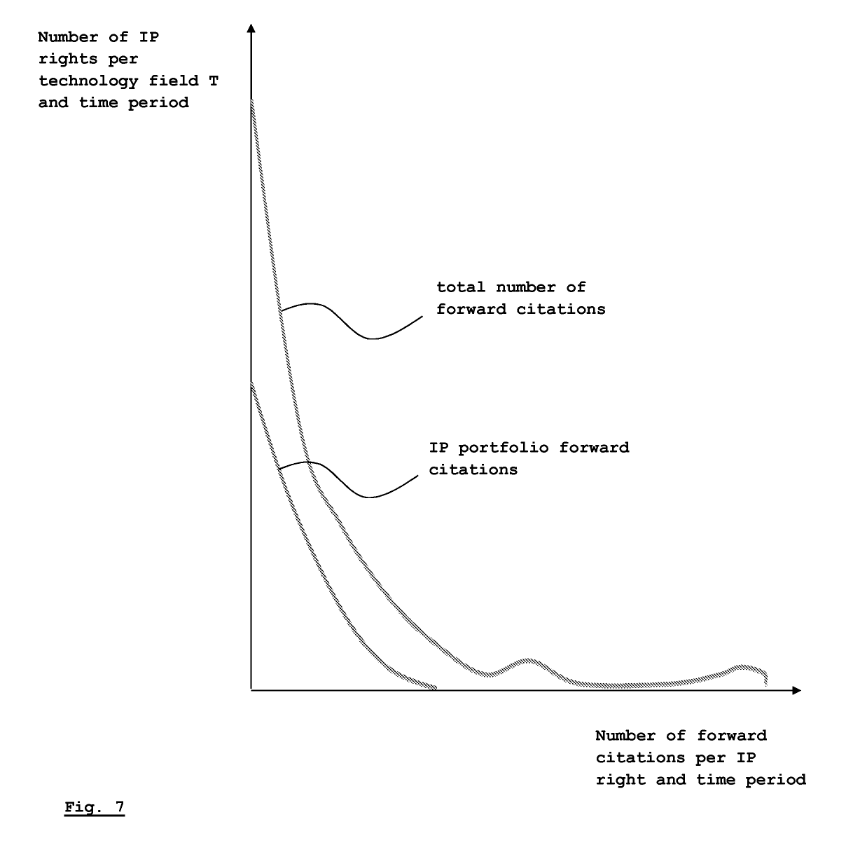

As depicted in FIG. 7, the number of IP rights per technology field T and time period can be plotted as a function of the number of forward citations per IP right and time period. A first curve represents a total number of forward citations per technology field T and time period, a second curve represents a number of forward citation for an IP portfolio per technology field T and time period. Measurement of the signal ratio may occur by totaling the individual surfaces below the two curves depicted in FIG. 7. It is of course possible, to plot and print more than one IP portfolio forward citation curve for more than one company, so that a comparison of IP portfolio forward citation curves of different companies for one technology field T and one time period is possible.

As discussed, a simple counting of forward citations C is not sufficient. Apart from the presented adjustments one may also use the following methodology. A regression model is the basis to calculate the distribution function of the patents in focus, differentiated by age, technology class and number of citations. First the forward citations per patent are plotted in a diagram. A forward citation signal being considered for the individual Intellectual Property technology relevance is normalized to be included in a predetermined value range. The idea is to receive a value for the individual forward citation C between “0” and “1” for each patent in focus, as the form of the distribution function differs for each patent-cluster. It is therefore normalized. For each patent an integral is calculated, leading to the aimed value between “0” and “1”. This value for the forward citation C is added in the individual IP technology relevance R of the IP right valuation index P.

As there are huge differences between patent distributions of forward citations, and because these differences are significant for the measurement of the individual Intellectual Property technology relevance R, they were amplified. A patent which is cited e.g. twenty times in one year is much more technologically relevant if comparable patents are only cited a few times, than if they are cited also e.g. nineteen times. For this the IP right valuation index P calculates the standard deviation and takes this as a weighting factor. A forward citation signal being considered for the individual IP technology relevance R comprises a standard deviation factor of each cited IP right, said standard deviation factor is included in a predetermined value range. The following relationship is used:

$$0 \leq \frac{σ * C}{1 + σ} < C$$

between the standard deviation σ of the individual forward citation C and the individual forward citation C itself. If the value of the standard deviation σ tends against “0”, the technological relevance of the patent would not lead to a competitive advantage in the selected setting (i.e. the chosen competitors, technology field T, patent age A). On the other side, for elevated values of the standard deviation σ, the patent exhibits a distinct individual IP technology relevance R.

Another point one must consider in these measurements is the mathematical standardization of individual forward citations cᵢ for patent members of a patent family. By doing so, one avoids that different patent members of one and the same patent family are differently measured, even if the underlying technology field T is the same. Therefore, each cited IP right is identifiable by means of an identification number; the identification number is a priority number; and two or more cited IP rights having the same priority number form individual members of a family. A quality indicator signal being considered for the individual IP technology relevance R comprises a family size factor, the family size factor is an integer and indicative for a number of individual members of a family.

One major consideration within the methodology deals with the weighting of the number and the different types of patent rights. The number of countries and jurisdictions in which patent protection is sought for a particular invention is correlated with the value of the invention and thus with the value of any single patent right. Quantitative data show that an invention with just one patent right has low technological relevance.

Depending on the country and its “patent grant procedure”, 65% to 40% of all patents applications were granted. In addition, depending on the country and time period considered between 7% and 10% of all patents granted were opposed.

Therefore, a forward citation signal being considered for the individual IP technology relevance R comprises an IP legal status factor, the IP legal status factor is predetermined and indicative for a legal status of an individual member of a family. The legal status describes the type of patent document, whether a patent is a filed patent application or an unexamined patent publication, whether a patent is already granted, opposed or not, still in vigor or abandoned.

In many countries there exist different kinds of patent documents. These documents are classified according to the following six types of patent documents with a specific weighting factor according to Table 2:

TABLE 2

| Type of Patent Document | Weighting Factor |
|---|---|
| Filed Patent Application | 0.3 |
| Unexamined Patent Publication | 0.5 |
| Utility Patent | 0.7 |
| Granted Patent | 1.0 |
| Opposed Patent | 1.2 |
| Other Patent Document | 0.0 |

### Individual IP Market Strength M

The second dimension covered by the IP right valuation index P is the market-view. The strength of this factor, as it is measured individually for each patent selected, is a second implementation of the bottom-up method.

The IP right valuation index P is measured for different countries worldwide. The size of a patent family, measured as the number of jurisdictions in which a patent grant has been sought, and the survival span of patents, i.e. the time from application to non-renewal or to expiration, are highly correlated. The IP right to be valuated is identifiable by means of at least one identification number; the identification number is a priority number and a filing number; and the IP right to be valuated forms a family with individual members having the same priority number but different filing numbers. The IP right valuation index P is multiplied with an individual IP market strength M comprising a family size factor, the family size factor is an integer and indicative for a number of individual members of said family. The IP right valuation index P is multiplied with an IP market strength M comprising an IP legal status factor, said Intellectual Property legal status factor is predetermined and indicative for a legal status of an individual member of a family.

A patent and the strength of its portfolio are related to the market and to its economic importance. The individual IP market strength M is measured for a chosen number of countries. The IP right to be valuated has a country code, the country code indicates a filing country of the IP right to be valuated; and the IP right valuation index P is multiplied with an individual IP market strength M comprising a purchasing power factor, the purchasing power factor is predetermined and indicative for a purchasing power in the filing country. The IP right valuation index P in its basic version therefore uses the Purchasing Power Parity (PPP). The PPP already represents a valid indicator for the wealth of a nation and shows its worldwide economic importance. To have a normalized figure, the PPPSH (Purchasing Power Parity share of world total) from the database of the International Monetary Fund (IMF) is used. The individual patent market strength M is measured by accumulating individual rates of those countries where a patent is filed. Therefore, any one-country dependency like in the Patent Asset Index is avoided. For European patent (EP) documents, where in general several countries are designated, one assumes an average distribution for the PPPSH-measurement, based on the top-ten filing company's activities.

In order to individualize and concretize the market effect, the IP right valuation index P also includes a qualitative country rating (e.g. based on social, political and legal risks, like BERI) and an industry weighting factor for each country. The assumption that lies behind the ladder is to consider the specific importance of an industry and the related technology in a chosen market. E.g. it is possible that a first country has a significant higher PPP than another country. However a specific industry might be of extreme importance in the other country. Therefore the patent has a bigger impact in the other country than in the first country. The IP right to be valuated has a country code, the country code indicates a filing country of the IP right to be valuated; and the IP right valuation index P is multiplied with an individual IP market strength M comprising a technology importance factor, the technology importance factor is predetermined and indicative for a technology importance of the IP right to be valuated in the filing country. In order to measure the impact, one uses the rate of GDP of a selected industry in each country as obtained from official databases. This rate is normalized and used as weighting factor for the PPPSH.

A further concretization is possible based on trend observations, which can be measured. Based on predictive PPPSH and technology data, one builds a relationship between a future importance of the individual IP market strength M and its patent portfolio. E.g. what is the possibility that a specific industry gains more importance in the next years in a first country than in another country. The possibility of a trend realization is introduced in the individual IP market strength M by a correction value.

Another important point to consider within the worldwide calculation is to examine and include the differences of citation numbers obtained from different national patent offices. Different national and regional patent offices have different citation practices. In other words, the cited IP right has a country code, said country code indicates a filing country of the cited IP right; a forward citation signal being considered for the individual IP technology relevance R comprises a citation practice factor, said citation practice factor is predetermined and indicative for a citation practice in said filing country.

It is possible, that companies which preferentially file in countries with well marked citation practice, receive a better patent index rating than those, which file in countries with less marked citation practice. In the USA, e.g., disclosure of all known prior art in relation to a patent is mandatory. Therefore, US patent publications list an elevated number of citations. In Japan, where in comparison to the size of its population, a relatively high number of patents is filed, the high filing activity results in a correspondingly high number of citations. Moreover, national patent offices have the tendency to cite national patent members of patent families. Therefore, a correction of such differences of the citation numbers is made, such that a patent member obtains the number of forward citations of the entire patent family.

### IP Portfolio Strength N

The third factor represents the top-down part of the IP right valuation index P. The theoretical argumentation that lies behind is that a patent portfolio as a whole is more worth than the sum of each of its patents. Therefore, the top down method introduces the importance of a patent portfolio as a whole for the company, including strategic synergies between patents. The factor may furthermore include an technology sector and/or industry sector specific variable enabling a more realistic analysis.

The IP portfolio strength N is obtained by a function that displays only the technological synergies between the patents. Product related synergies cannot be analyzed by quantitative databases. This would only be possible based on supplementary analysis individually adapted to the company in focus.

The importance of patent portfolios or patent clusters is undisputed. Patent clusters are groups of patents that can be assigned to a particular technology. The cluster definition may be as broad or narrow as needed for the portfolio analysis. The value of a single patent depends on the patent portfolio to which the patent in question belongs. Companies may use patent portfolios to pursue so-called “chessboard” or “thicket” strategies for competitive advantage. The value of a single patent may not only depend on the size of its surrounding portfolio, but also on the function the single patent serves within the portfolio. Therefore there exists a bi-directional relationship between a patent and its surrounding portfolio.

The easiest way to analyze the IP portfolio strength N is to count the number of patents of a company in the selected technology field T which is often used.

For doing so, a technology field request signal is generated in the computing device, the technology field request signal relates to the technology field signal. The technology field request signal is transmitted to a computerized storage device configured to store an IP right, said IP right being classified in a technology field T. The computing device, computerized storage device and kind of transmission occur in the same way as explained beforehand. In response to the request, the computing device captures a total number signal relating to a total number of IP rights being classified in the technology field T of the technology field signal transmitted from the computerized storage device. An IP portfolio signal is determined using the computing device, the IP portfolio signal relates to the number of IP rights having the same ownership as the IP right to be evaluated within the total number signal. This method would weight too much the value of the portfolio. Therefore, the IP portfolio strength N uses the following logarithm-based function:

$$N = 1 + ln ( 1 + α * \frac{k}{{N}_{Ges}} )$$

Where k represents the number of patents in one technology field T by the company; NGes counts all patents of the selected technology field T; α is a scaling factor. For α=1 and for a patent portfolio, that covers half of the patents of a technology field T, results an IP portfolio strength N=1.41.

The calculation of the IP portfolio strength N can be extended and further specified by implementing the Technology-Field-Index (TFx). Additionally to the above explained method, the computing device captures an average number signal relating to an average value of IP portfolios within the xth technology field T. The computing device then relates this technology field signal to a technology relevance signal, a market strength signal and a market share signal transmitted from the computerized storage device. This extension would lead to the following formula:

$$N = \frac{{R}_{i} * {M}_{i} * {MS}_{i}}{{TF}_{X}} * ( 1 + ln ( 1 + α * \frac{k}{{N}_{Ges}} ) )$$

Where Ri represents the technological relevance, Mi represents the market strength and MSi represents the market share of the company i in focus; TFx represents the Technology-Field-Index for the selected xth technology field T; k represents the number of patents in one technology field T by the company; NGes counts all patents of the selected technology field T; and α is a scaling factor.

Using the IP right valuation index P to analyze the patent portfolio of a company in comparison to its competitors leads to different outcomes on an aggregate level. I.e. the comparison with an industry sector average provides indications on the typical patent portfolio internationalization and market strength of patent portfolios. Three main steps have to be undertaken in the analysis:
As first step a distinct definition of the field of technology and/or industry sector to be analyzed deriving afterwards potential benchmarking entities and/or companies is necessary. The potential benchmarking entities to be selected may be chosen by the company in focus. However this may lead to a bias in the analysis. Taking e.g. the top 10 companies according turnover vs. patent portfolio strength may already lead to important changes in the results. The more objective way will be to define a standardized set of companies. This set will be defined by ranking the companies based on the market share and turnover.
The second step includes the calculation of the IP right valuation index P and its three factors (R; M; N) for each company selected in step one. The selected patent portfolios will be analyzed according to the given IP right valuation index P.
As third step the weighted technology field/industry average will be calculated. A simple summation and division of the IP right valuation index P values of the selected companies would not represent the real average. Therefore we would weigh the importance of each company by taken into account the market share of the company.
The Technology-Field-Index TFx as an average value for the xth technological field T will be calculated as follows:

$${TF}_{x} = \frac{{\sum }_{i}^{n} {R}_{i} * {M}_{i} * {MS}_{i}}{n}$$

Where Ri represents the technological relevance, Mi represents the market strength and, MSi represents the market share of a selected company, i being part of the standardized company set within the xth technology field T as identified; n counts the number of selected companies.
The outcome—the weighted average of the IP right valuation index P values—can be used as a benchmark for the company in focus to analyze its portfolio and compare it not only with some selected competitors but also with several companies in the selected field of technology and/or industry sector.

Apart from this basic function the IP portfolio strength N can also connect its results with the outcomes of typical patent landscape analysis. For this one may define one or more main strategic technology clusters within a technology field T. Based on this and the related key words one may define a “technological distance” between individual patents of a main strategic technology cluster and the mathematical center of said cluster. By accumulating “technological distances” for different patents of the main strategic technology cluster and normalizing them between values “0” and “1”, one obtains a weighting factor for the technological synergy strength of a patent portfolio.

If a firm's “quality” of patents increases, so that on average these patents receive one additional citation, the firm's market value would increase by a factor of 3%. This is a very large impact, but then one has to keep in mind that getting an additional citation per patent is very hard, considering that the mean number of citations per patent is just over three and that the distribution is extremely skewed, with about one-quarter receiving none.

It is further possible to link the IP right valuation index P through scoring to the income of a company. One method which is generally accepted by the skilled person and commonly used, consists in using a prospective financial model based upon the business supported by the IP and to calculate the net present value (NPV) of the incremental profit attributed to the IP rights.

Such a strategic patenting is believed to substantially affect patent examination procedures because it simultaneously increases the number of filed patent applications and reduces their average quality: firms file more patents for a given invention or have a higher propensity to patent inventions of a lower quality. The direct consequence of these “strategic hypes” is a sharp increase in the workload—and hence backlogs—in patent offices, generating uncertainty on the markets for technology.

The advent of the Intangible Asset Market (IAM) Index and the Technology Risk-Reward Unit (TRRU™) valuation model brings, for the first time, many of the same techniques used in financial markets to the intellectual property markets.

We claim:

1. A computer-implemented method for creating an Intellectual Property right valuation index for an Intellectual Property portfolio related to an Intellectual Property right, said method comprising the steps of:
generating in a computing device at least one quality indicator request signal relating to said Intellectual Property right to be valuated;
transmitting said quality indicator request signal to at least one computerized storage device configured to store at least one quality indicator data of said Intellectual Property right to be valuated;
capturing at least one quality indicator signal from said computerized storage device, said quality indicator signal being responsive to said quality indicator request signal and relate to said stored quality indicator data of said Intellectual Property right to be valuated;
generating in a computing device at least one technology field signal relating to at least one technology field of said Intellectual Property right to be valuated;
measuring in said computing device an individual Intellectual Property technology relevance comprising a signal ratio of said generated technology field signal and said captured quality indicator signal;
generating in a computing device at least one technology field request signal relating to said technology field signal;
transmitting said technology field request signal to at least one computerized storage device configured to store at least one Intellectual Property right, said stored Intellectual Property right being classified in at least one technology field;
capturing at least one total number signal from said computerized storage device, said total number signal being responsive to said technology field request signal and relate to a total number of Intellectual Property rights being classified in the technology field of said technology field signal;
determining in a computing device an Intellectual Property portfolio signal relating to the number of Intellectual Property rights within the captured total number signal having the ownership of said Intellectual Property right to be valuated;
measuring in said computing device an Intellectual Property portfolio strength comprising a signal ratio of said determined Intellectual Property portfolio signal and said captured total number signal; and
creating an Intellectual Property right valuation index for said Intellectual Property right to be valuated comprising a product of said individual Intellectual Property technology relevance and said Intellectual Property portfolio strength.

2. The method of claim 1, wherein said captured quality indicator signal comprises at least one of:
stored forward citation data with zero or more forward cited Intellectual Property rights, each forward cited Intellectual Property right having a at least one of a creation date and a publication date;
stored backward citation data with zero or more backward cited Intellectual Property rights, each backward cited Intellectual Property right having at least one of a creation date and a publication date;
stored Intellectual Property age data with zero or more backward cited Intellectual Property rights, each age-related Intellectual Property right having at least one of a creation date or publication date;
stored Intellectual Property inventor data with zero or more backward cited Intellectual Property rights, each inventor-related Intellectual Property right having at least one of a creation date and publication date.

3. The method of claim 2, wherein the step of measuring an individual Intellectual Property technology relevance comprises at least one of:
comparison of whether said creation date or publication date is similar to a creation date of said Intellectual Property right to be valuated, forward citation data having a citation date similar to said creation date is positively compared; and consideration of positively compared forward citation data for measuring said individual Intellectual Property technology relevance;
comparison of whether a creation date or a publication date of forward citation data is included in a time period of a life cycle of said technology filed signal, said time period starts with a creation date of said Intellectual Property right to be valuated, forward citation data having a creation date included in said time period is positively compared; and consideration of positively compared forward citation data for measuring said individual Intellectual Property technology relevance;
determination of a country code, said country code indicates a filing country of said forward cited Intellectual Property right; retrieval of a citation practice factor stored in a computing device, said citation practice factor is predetermined and indicative for a citation practice in said filing country; creation of a product of forward citation data with said forward cited Intellectual Property right having said country code and said citation practice factor; and consideration of said product for measuring said individual Intellectual Property technology relevance.

4. The method of claim 2, wherein the step of measuring an individual Intellectual Property technology relevance comprises at least one of:
comparison of whether said creation date or publication date is similar to a creation date of said Intellectual Property right to be valuated, backward citation data having a citation date similar to said creation date is positively compared; and consideration of positively compared backward citation data for measuring said individual Intellectual Property technology relevance;
comparison of whether a creation date or a publication date of backward citation data is included in a time period of a life cycle of said technology filed signal, said time period starts with a creation date of said Intellectual Property right to be valuated, backward citation data having a creation date included in said time period is positively compared; and consideration of positively compared backward citation data for measuring said individual Intellectual Property technology relevance;
determination of a country code, said country code indicates a filing country of said backward cited Intellectual Property right; retrieval of a citation practice factor stored in a computing device, said citation practice factor is predetermined and indicative for a citation practice in said filing country; creation of a product of backward citation data with said backward cited Intellectual Property right having said country code and said citation practice factor; and consideration of said product for measuring said individual Intellectual Property technology relevance.

5. The method of claim 2, wherein the step of measuring an individual Intellectual Property technology relevance comprises:
comparison of whether said creation date is similar to a creation date of said Intellectual Property right to be valuated, Intellectual Property age data having a creation date similar to the creation date of said Intellectual Property right is positively compared; and consideration of positively compared Intellectual Property age data for measuring said individual Intellectual Property technology relevance;
comparison of whether a creation date of Intellectual Property age data is included in a time period of a life cycle of said technology filed signal, said time period starts with a creation date of said Intellectual Property right to be valuated, Intellectual Property age data having a creation date included in said time period is positively compared; and consideration of positively compared Intellectual Property age data for measuring said individual Intellectual Property technology relevance.

6. The method of claim 2, wherein the step of measuring an individual Intellectual Property technology relevance comprises:
comparison of whether said creation date is similar to a creation date of said Intellectual Property right to be valuated, Intellectual Property inventor data having a creation date similar to the creation date of said Intellectual Property right is positively compared; and consideration of positively compared Intellectual Property inventor data for measuring said individual Intellectual Property technology relevance;
comparison of whether a creation date of Intellectual Property inventor data is included in a time period of a life cycle of said technology filed signal, said time period starts with a creation date of said Intellectual Property right to be valuated, Intellectual Property inventor data having a creation date included in said time period is positively compared; and consideration of positively compared Intellectual Property inventor data for measuring said individual Intellectual Property technology relevance.

7. The method of claim 1, wherein said captured quality indicator signal being considered for the individual Intellectual Property technology relevance is normalized to be included in a predetermined value range.

8. The method of claim 1, wherein said captured quality indicator signal being considered for the individual Intellectual Property technology relevance comprises a standard deviation factor of each cited Intellectual Property right, said standard deviation factor is included in a predetermined value range.

9. The method of claim 1, wherein if said captured quality indicator signal relates to one or more Intellectual Property rights; each related Intellectual Property right is identifiable by means of at least one identification number; said identification number is a priority number; two or more related Intellectual Property rights having the same priority number form individual members of a family; and said captured quality indicator signal for being considered for the individual Intellectual Property technology relevance comprises at least one of:
a family size factor, said family size factor is an integer and indicative for a number of individual members of a family;
an Intellectual Property legal status factor, said Intellectual Property legal status factor is predetermined and indicative for a legal status of an individual member of a family.

10. The method of claim 1, wherein the Intellectual Property right to be valuated has a country code, said country code indicates a filing country of said Intellectual Property right to be valuated; and said Intellectual Property right valuation index is multiplied with an individual Intellectual Property market strength comprising a purchasing power factor, said purchasing power factor is predetermined and indicative for a purchasing power in said filing country; or
wherein the Intellectual Property right to be valuated has a country code, said country code indicates a filing country of said Intellectual Property right to be valuated; and said Intellectual Property right valuation index is multiplied with an individual Intellectual Property market strength comprising a technology importance factor, said technology importance factor is predetermined and indicative for a technology importance of said Intellectual Property right to be valuated in said filing country.

11. The method of claim 1, wherein the Intellectual Property right to be valuated is identifiable by means of at least one identification number; said identification number is a priority number and a filing number; the Intellectual Property right to be valuated forms a family with individual members having the same priority number but different filing numbers; said Intellectual Property right valuation index is at least one of:
multiplied with a market strength comprising a family size factor, said family size factor is an integer and indicative for a number of individual members of said family;
multiplied with a market strength comprising an Intellectual Property legal status factor, said Intellectual Property legal status factor is predetermined and indicative for a legal status of an individual member of a family.

12. The method of claim 1, wherein said Intellectual Property portfolio strength comprising a logarithm of a signal ratio of said Intellectual Property portfolio signal and said total number signal.
